(19) United States
(12) Patent Application Publication
(10) Pub. No.: US 2025/0077251 A1
(43) Pub. Date: Mar. 6, 2025

(54) CONTEXT SWITCH REDUCTION FOR VIRTUAL MACHINE EXITS

(71) Applicant: Red Hat, Inc., Raleigh, NC (US)

(72) Inventors: Michael Tsirkin, Ra’anana (IL); Karen Noel, Concord, NH (US)

(21) Appl. No.: 18/240,085

(22) Filed: Aug. 30, 2023

(51) Int. Cl. G06F 9/455

(52) U.S. Cl. CPC G06F 9/45558; G06F 2009/45575

(57) ABSTRACT

Systems, methods, and apparatuses for reducing context switches in a virtualized computing environment are provided herein. An example method comprises executing a supervisor, executing a first virtual machine on the supervisor, detecting a first exit from the first virtual machine, responsive to detecting the first exit, loading a userspace context without loading a supervisor context, executing a second virtual machine on the supervisor, detecting a second exit from the second virtual machine, and responsive to detecting the second exit, loading the supervisor context.

### BACKGROUND

Virtual machines often execute on a supervisor. Supervisors, in turn often execute separate from a userspace. A context switch is often required when transitioning between a supervisor, a virtual machine, and a userspace. Context switches often involve saving contents of a memory to storage, then loading new contents into the memory from storage.

### SUMMARY

Systems, methods, and apparatuses are provided for reducing context switches in a virtualized computing environment. In an example, a method comprises executing a supervisor, executing a first virtual machine on the supervisor, detecting a first exit from the first virtual machine, responsive to detecting the first exit, loading a userspace context without loading a supervisor context, executing a second virtual machine on the supervisor, detecting a second exit from the second virtual machine, and responsive to detecting the second exit, loading the supervisor context.

In another example, a system comprises a memory and a processing device configured to execute a supervisor, execute a first virtual machine on the supervisor, detect a first exit from the first virtual machine, wherein the first exit has a first exit status that is one of a first type or a second type, determine the first exit status as being of the first type, responsive to determining the first exit status is of the first type, load a supervisor context, execute a second virtual machine, detect a second exit from the second virtual machine, wherein the second exit has a second exit status that is one of the first type or the second type, determine the second exit status as being of the second type, responsive to determining the second exit status is of the second type, load a userspace context.

In yet another example, a non-volatile computer-readable memory stores instructions which, when executed by a processing device, cause the processing device to execute a supervisor, execute a virtual machine on the supervisor, detect a first exit from the virtual machine, wherein the first exit has a first exit status that is one of a first type or a second type, determine the first exit status as being of the first type, responsive to determining the first exit status is of the first type, load a supervisor context, detect a second exit from the virtual machine, wherein the second exit has a second exit status that is one of the first type or the second type, determine the second exit status as being of the second type, responsive to determining the second exit status is of the second type, load a userspace context.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the Figures and the Detailed Description. Moreover, it should be noted that the language used in this specification has been principally selected for readability and instructional purposes, and not to limit the scope of the inventive subject matter.

### BRIEF DESCRIPTION OF THE DRAWINGS

The description will be more fully understood with reference to the following figures, which are presented as exemplary aspects of the disclosure and should not be construed as a complete recitation of the scope of the disclosure, wherein:

FIG. 1 illustrates a block diagram of an example system, according to example embodiments of the present disclosure.

FIG. 2 illustrates a flowchart of an example method for reducing context switches in a virtualized computing environment, according to example embodiments of the present disclosure.

FIG. 3A and FIG. 3B illustrate a flow diagram of an example method, according to example embodiments of the present disclosure.

FIG. 4 illustrates a flowchart of an example method for determining whether context switches are required, according to example embodiments of the present disclosure.

FIG. 5 illustrates a flowchart of an example method for determining what context to load, according to example embodiments of the present disclosure.

FIG. 6 illustrates a block diagram of an example system with data flows, according to example embodiments of the present disclosure.

### DETAILED DESCRIPTION

Techniques are disclosed herein for reducing context switches in a virtualized computing environment. When performing tasks in a virtualized computing environment, various events may require a system to switch between a virtual machine, a supervisor, and a userspace. Transitioning between the virtual machine and the supervisor requires a context switch, which may involve saving contents of a memory related to the virtual machine into storage, then loading new contents related to the supervisor into the memory from storage. Transitioning between the supervisor and the userspace requires a similar context switch.

Typically, when an exit from the virtual machine to the userspace is required, existing systems first perform a context switch from the virtual machine to the supervisor, followed by a second context switch from the supervisor to the userspace. This is because standard system calls return to a last executed instruction upon exiting from a process, but utilizes a large amount of computational power since it requires most processes to stop while two consecutive context switches are performed. It is therefore desirable to create a system that allows a single context switch to take place in order to reduce computational overhead and increase virtual machine exit speeds. This solution poses new problems, however, with additional software infrastructure required to detect and handle a desired switch directly to the userspace. This is because traditional virtual machine exits utilize standard system calls, which do not allow for direct exits to userspace.

A custom system call can be implemented which determines which context switch is required when exiting the virtual machine and then carries out an appropriate context switch. Such a system call may require data about the exit to be provided in order to determine the appropriate context switch. The custom system call may determine a reason for the exit (i.e. a crash of the virtual machine), determine whether the exit should be handled by the supervisor or the userspace (i.e. if the exit is due to a page fault, the supervisor would handle the exit), and then perform a context switch to the supervisor or the userspace responsive to the determination regarding which should handle the exit. When determining an appropriate context switch, the custom system call may consult a lookup table containing a list of exit codes and/or reasons and corresponding appropriate exit destinations (userspace or supervisor) for each exit code or reason.

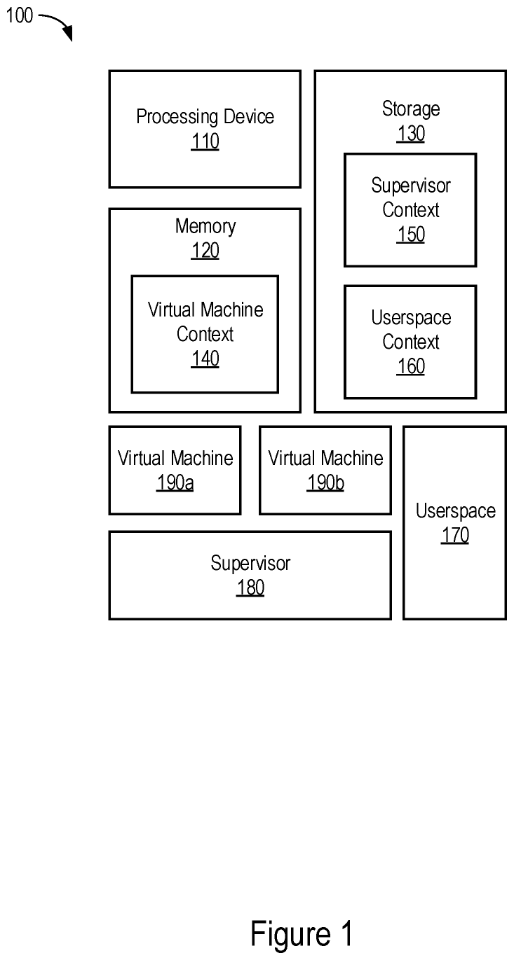

FIG. 1 illustrates a block diagram of an example system 100, according to example embodiments of the present disclosure. A processing device 110 is in communication with a memory 120 and a storage 130. The memory 120 may contain one of a group comprising a virtual machine context 140, a supervisor context 150, or a userspace context 160, with the remaining two elements of the group being located in the storage 130. The processing device 110 executes a userspace 170, with a supervisor 180 executing outside of the userspace 170, and a first virtual machine 190a and a second virtual machine 190b (virtual machines 190, collectively) executing on the supervisor 180. The virtual machine context 140, the supervisor context 150, and the userspace context 160 may contain complete contents of the memory 120 or partial contents of the memory 120. It will be appreciated that the system 100 may be implemented in a cloud computing environment, and as such the processing device 110 may in fact be multiple processing devices 110. The system 100 itself may also be implemented within a virtual machine running in a container, with the processing device 110 taking the form of a virtual processing device emulated in the container.

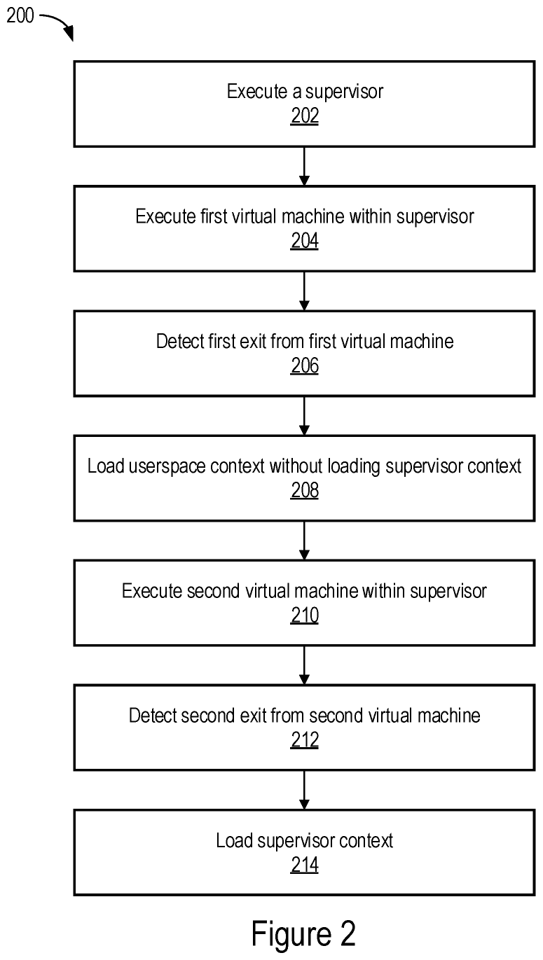

FIG. 2 illustrates a flowchart of an example method 200 for reducing context switches in a virtualized computing environment, according to example embodiments of the present disclosure. It will be appreciated that the method 200 is presented with a high degree of abstraction, and that additional steps not mentioned herein or substeps of steps included herein may be included.

At block 202, an example processing device executes a supervisor. For example, upon receiving input from a user, the processing device 110 may execute a hypervisor (the supervisor 180) outside of the already-running userspace 170 in order to execute one or more virtual machines 190. The userspace context 160 is written to the storage 130 and then the supervisor context 150 is created and written to the memory 120, overwriting the userspace context 160. The supervisor 180 may be a hypervisor, and may oversee multiple virtual machines 190. The supervisor 180 may handle some errors that may be encountered during execution of the virtual machines 190. The supervisor 180 may execute within a container or a hypervisor. The userspace context 160 may be saved to storage 130 at this time in order to preserve a state of the userspace 170 upon executing the supervisor 180. When saving the userspace context 160, the processing device 110 may additionally save an execution address to a register in the memory 120 that may be used later to return to a correct position in an instruction sequence to resume execution of the userspace 170. Execution of the supervisor 180 may be user-initiated or may be automatic. The supervisor context 150 may be loaded from the memory 120 or may be created upon execution.

At block 204, the example processing device executes a first virtual machine on the supervisor. For example, upon receiving input from the user, the processing device 110 may save the supervisor context 150 to the storage 130. Continuing the example, a first virtual machine 190a for taking and processing login information is created by writing the virtual machine context 140 to the memory 120, overwriting the supervisor context 150, then beginning execution of the first virtual machine 190a. The first virtual machine 190a may execute a plurality of applications within the first virtual machine 190a. The system 100 may execute multiple virtual machines 190 in parallel, providing each with a virtual processing device that may be subject to similar context switch requirements to those of the processing device 110. The supervisor context 150 may be saved to the storage 130, and the virtual machine context 140 may be either created or loaded into the memory 120 from the storage 130. The execution of the first virtual machine 190a may be automatic or may be responsive to user input.

At block 206, the example processing device detects a first exit from the first virtual machine. For example, an exit of the first type (indicative of a need to switch to the supervisor 180) may be detected, the exit being caused by a page fault which must be handled in the supervisor 180. An exit from the first virtual machine 190a may be initiated by a number of events, including but not limited to user input, a timeout, completion of tasks that the first virtual machine 190a was executed to conduct, an error, or another event. Exits from the first virtual machine 190a may be sorted into two types depending on an intended destination context upon exiting. A first type may be indicative of a traditional exit, in which the supervisor context 150 is loaded, while a second type may be indicative of an exit directly to the userspace 170. The exit type may be determined by a cause of the exit.

At block 208, the example processing device loads the userspace context without loading the supervisor context. For example, a custom system call may be employed which determines via a flag in the memory 120 that the exit is due to a page fault that needs to be handled by the supervisor 180, and that the virtual machine context 140 needs to be saved before exiting so that execution of the first virtual machine 190a may be resumed after resolving the page fault. The processing device 110 saves the virtual machine context 140 to the storage 130 and then loads the userspace context 160 from the storage 130, placing the system 100 into the userspace 170. Loading the userspace context 160 without first loading the supervisor context 150 may require a custom system call since standard system calls initiate a return upon exit, sending the system 100 to a last context before executing the first virtual machine 190a. As this would cause the system 100 to load the supervisor context 150 and waste both time and computing resources, the custom system call may be implemented to operate whenever an exit of the second type is detected. The custom system call may or may not save the virtual machine context 140 to the storage 130 depending on a configuration of the custom system call and a type of the exit. The custom system call may exit to an address saved at block 202 in a register of the memory 120, as opposed to a standard system call that exits to a next instruction at an address at which the system 100 was executing instructions before the first virtual machine 190a was executed. In some embodiments, an exit from the first virtual machine 190a may include an indication of whether the virtual machine context 140 should be saved to the storage 130.

At block 210, the example processing device executes a second virtual machine on the supervisor. For example, after the first exit is conducted, the processing device 110 may execute a context switch to the supervisor 180 (e.g., a hypervisor), then load the virtual machine context 140 from the first virtual machine 190a to execute the second virtual machine 190b, thereby resuming execution of the first virtual machine 190a for receiving and processing login information. Any amount of time may pass between the first exit and block 210, and the first virtual machine 190a may execute one or more additional times before the second virtual machine 190b is executed. The second virtual machine 190b may be a same virtual machine as the first virtual machine 190a. Before executing the second virtual machine 190b, a context switch from the userspace 170 to the supervisor 180 may be required.

At block 212, the example processing device detects a second exit from the second virtual machine. For example, the second exit may be caused by a page fault and may thus be of the first type, indicative of a need to switch to the supervisor context 150. Like the first exit, the second exit from the second virtual machine 190b may be initiated by a number of events, including but not limited to user input, a timeout, completion of tasks that the second virtual machine 190b was executed to conduct, an error, or another event. The second exit may also be of the first type or the second type.

At block 214, the example processing device loads the supervisor context. For example, the second exit may be caused by a page fault that needs to be handled in the supervisor 180. The second exit may include an indication that the virtual machine context 140 needs to be saved, so the processing device 110 saves the virtual machine context 140 to the storage 130 and loads the supervisor context 150 into the memory 120. This may proceed in a similar manner to a traditional virtual machine exit. As with the first exit, an indication of whether to save the virtual machine context 140 may be provided.

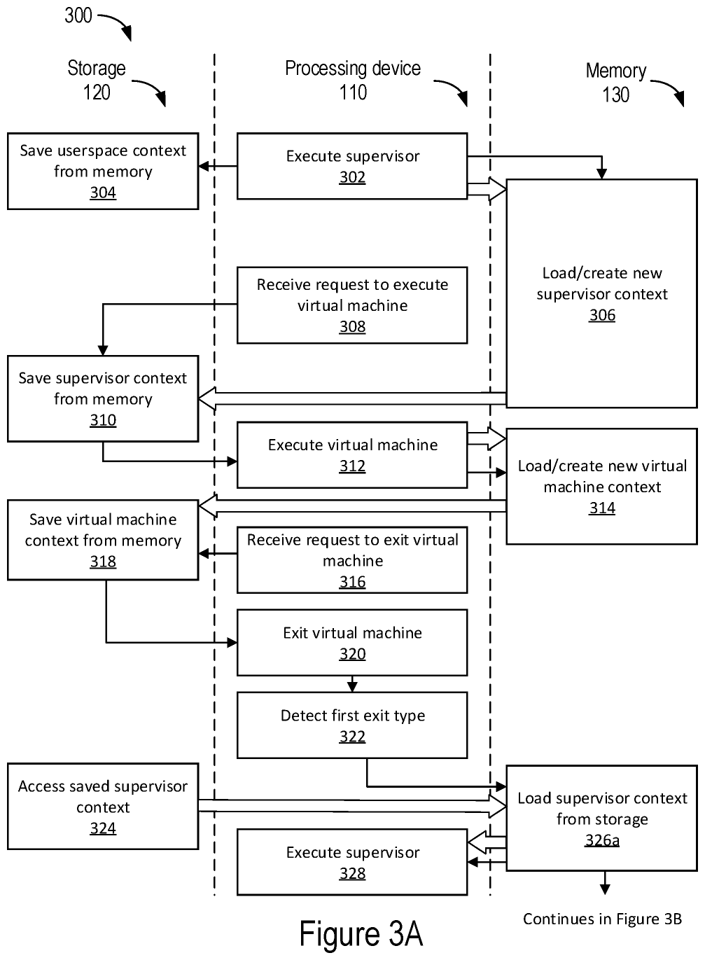

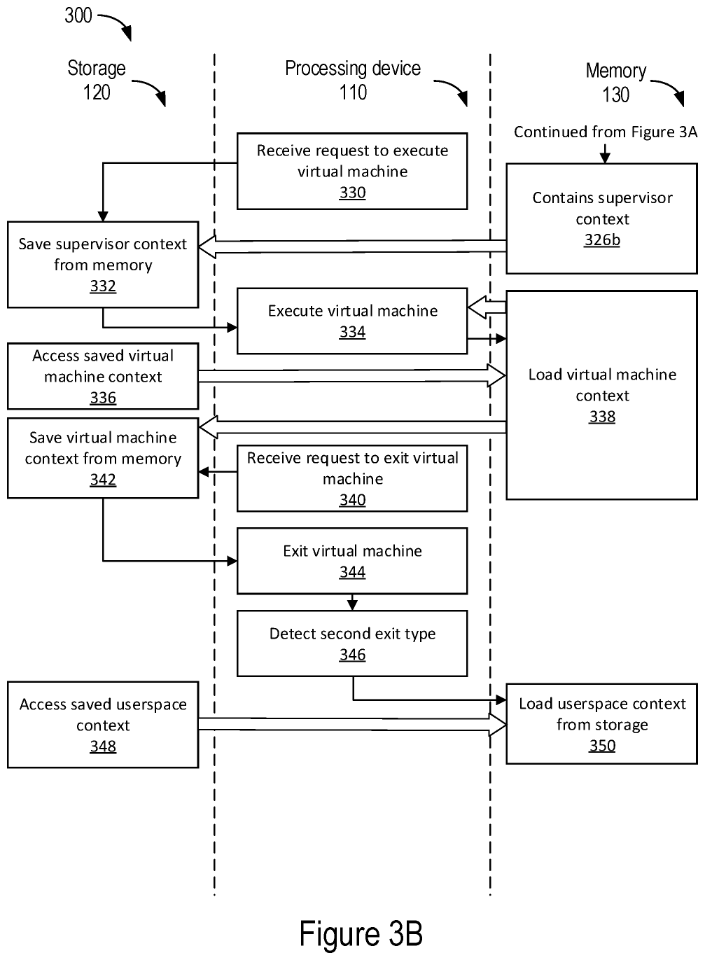

FIG. 3A and FIG. 3B illustrate a flow diagram of an example method 300, according to example embodiments of the present disclosure. It will be appreciated that the method 200 is presented with a high degree of abstraction, and that additional steps not mentioned herein or substeps of steps included herein may be included. It will also be appreciated that the timing diagram provided in FIGS. 3A and 3B is for illustrative purposes and is not intended to be limiting. Actual event timings may therefore deviate from what is depicted herein, with events potentially happening in an order different from that which is illustrated.

Starting in FIG. 3A, in preparation to execute a first virtual machine 190a, an example processing device 110 may execute a supervisor 180 (block 302). This may involve saving a userspace context 160 to a storage 130 (block 304) in order to preserve a state of a userspace 170 before executing the supervisor 180. The processing device 110 may then create or load from the storage 130 a supervisor context 150 (block 306) by overwriting a memory 120 with contents pertinent to the supervisor 180. Once the supervisor 180 is executing, a request may be received to execute the first virtual machine 190a (block 308). Alternatively, the request to execute the first virtual machine 190a may be received before executing the supervisor 180, in which case the first virtual machine 190a may be executed as soon as the supervisor 180 is ready.

The processing device 110 may then save the supervisor context 150 to the storage 130 from the memory 120 (block 310) and begin executing first the virtual machine 190a (block 312). This may involve creating or loading from the storage 130 a virtual machine context 140 by overwriting the memory 120 with information pertinent to execution of the first virtual machine 190a (block 314). After executing for a period of time, a request may be received by the processing device 110 to exit the first virtual machine 190a (block 316). In response, the processing device 110 may determine whether the virtual machine context 140 should be saved to the storage 130. Upon determining that the virtual machine context 140 should be saved to the storage 130 (by checking a flag in the exit request, for example), the processing device 110 may save the virtual machine context 140 to the storage 130 from the memory 120 (block 318). The processing device 110 may then terminate execution of the first virtual machine 190a (block 320).

Upon exiting the first virtual machine 190a, the processing device 110 may determine which context should be loaded from the storage 130 to the memory 120. The processing device 110 may detect an exit type (block 322), where for example, a first exit type may be indicative of an exit to the supervisor 180 and a second exit type may be indicative of an exit to the userspace 170. For the purposes of illustration, the requested example exit is the result of a page fault which should be handled by the supervisor 180, and thus the exit is of the first type. Upon detecting the first exit type, the processing device 110 may retrieve the supervisor context 150 from the storage 130 (block 324) and load the supervisor context 150 into the memory 120 (block 326a) by overwriting the contents of the memory 120. The supervisor 180 then executes (block 328).

Continuing in FIG. 3B, the processing device 110 receives a request to execute a second virtual machine 190b (block 330). This request may be for a second execution of the first virtual machine 190a as that which executed in FIG. 3A or may be a different virtual machine. For the purposes of illustration, the present disclosure will proceed with a scenario wherein the first virtual machine 190a is requested to resume execution. The processing device 110 may save the supervisor context 150 to the storage 130 (block 332) from the memory 120 (block 326b). The processing device 110 may then load the context of the first virtual machine 190a from the storage 130 (block 336) into the memory 120 (block 338) and begins execution of the second virtual machine 190b (block 334). The second virtual machine 190b continues to execute for a period of time.

After some time has elapsed, the processing device 110 receives a request to exit the second virtual machine 190b (block 340). The exit request may include an indication of whether to save the virtual machine context 140, and may be of the first type or the second type. The processing device 110 may save the virtual machine context 140 to the storage 130 from the memory 120 (block 342) and terminate execution of the second virtual machine 190b (block 344). To determine what context to load, the processing device 110 may then determine whether the exit request is of the first type or the second type. For the purposes of illustration, the processing device 110 determines that this exit request is of the second type (block 346) and that the userspace context 160 should be loaded directly. The processing device 110 may then retrieve the userspace context 160 from the storage 130 (block 348) and load the userspace context 160 into the memory 120 (block 350).

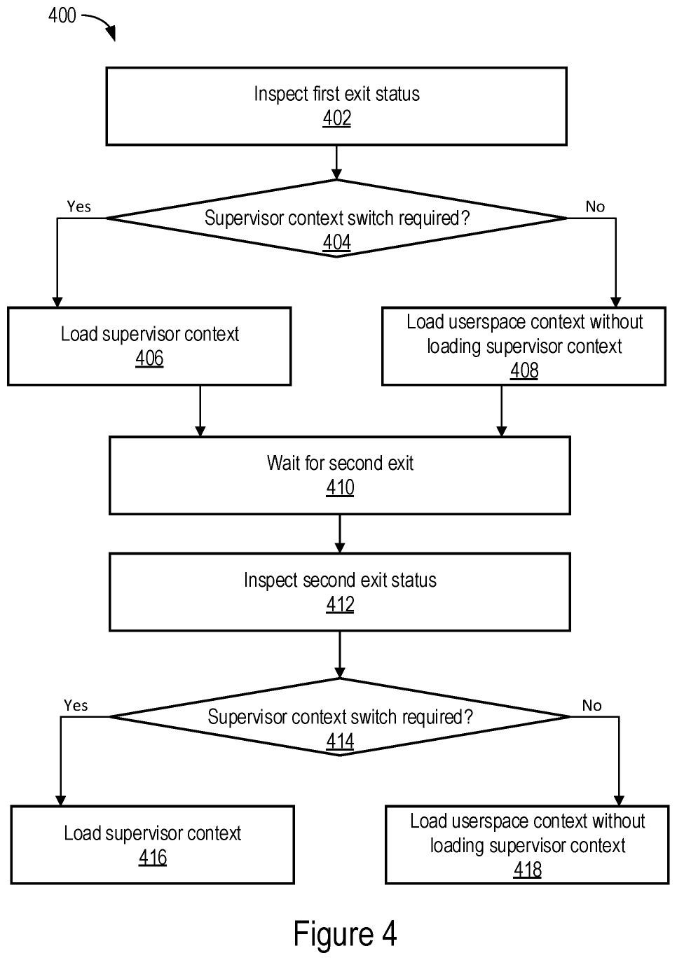

FIG. 4 illustrates a flowchart of an example method 400 for determining whether context switches are required, according to example embodiments of the present disclosure. It will be appreciated that the method 400 is presented with a high degree of abstraction, and that additional steps not mentioned herein or substeps of steps included herein may be included.

At block 402, an example processing device inspects a first exit status from a first virtual machine. The exit status may include an indication of a context to be loaded and may also include an indication of whether a current context should be saved. For example, an exit request responsive to user input indicating that the first virtual machine 190a should be terminated may indicate that a userspace context 160 should be loaded and that the virtual machine context 140 should not be saved.

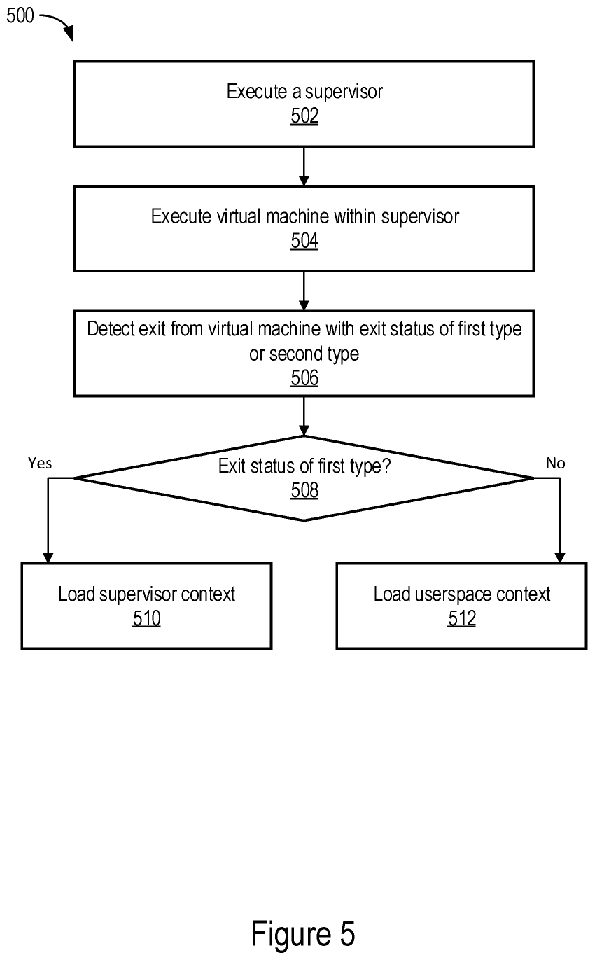

At block 404, the example processing device determines whether a supervisor context switch is required. For example, the processing device 110 may determine that a direct exit to the userspace 170 has been requested, which would not require a supervisor context 150 switch and so the processing device 110 would proceed to block 408. Since there are two possible contexts to be loaded in this example scenario, a determination by the processing device 110 whether the exit request requires loading of the supervisor context 150 is sufficient to determine what course of action should be taken. Some embodiments may provide for additional contexts to be loaded directly (in situations where additional layers of virtualization are present, for instance) and so may require more sophisticated mechanisms for determining a context that should be loaded (see FIG. 2, FIG. 3, and FIG. 5 for the exit type mechanism). When a supervisor context 150 switch is required, the processing device 110 proceeds to block 406. When a supervisor context 150 switch is not required, the processing device 110 proceeds to block 408.

At block 406, the example processing device loads the supervisor context from the storage into the memory. For example, the processing device 110 may immediately load the supervisor context 150 without saving the virtual machine context 140 to the storage 130 responsive to a determination that the virtual machine context 140 should not be saved. The processing device 110 may save the virtual machine context 140 to the storage 130 and may then load the supervisor context 150 into the memory 120. The processing device 110 may begin execution of the supervisor 180.

At block 408, the example processing device loads the userspace context without loading the supervisor context. For example, the processing device 110 may save the virtual machine context 140 to the storage 130 before loading the userspace context 160 into the memory 120. The processing device 110 may then retrieve an address for a next instruction within the instruction set associated with the userspace 170 and begin executing the userspace 170 beginning with the next instruction at the address. Certain exits will warrant a switch directly from the first virtual machine 190a to the userspace 170, including those that involve an error which must be dealt with in the userspace 170. Similarly to block 406, the processing device 110 may or may not save the virtual machine context 140 to the storage 130 before loading the userspace context 160 into the memory 120. Switching to the userspace 170 may involve retrieving an address of a next instruction within an instruction set associated with the userspace 170 from a register of the memory 120 or a space in the storage 130.

At block 410, the example processing device waits for a second exit from a second virtual machine. For example, the processing device 110 may reload the first virtual machine 190a as the second virtual machine 190b after handling a page fault in the supervisor 180, then the second exit may be requested by user input once all tasks for which the second virtual machine 190b was created have been completed. The second virtual machine 190b may be the first virtual machine 190a which was exited in blocks 402 through 408 or may be a different virtual machine. The processing device 110 may perform other tasks while waiting for the second exit, including but not limited to executing the second virtual machine 190b.

At block 412, the example processing device inspects the second exit status. For example, the second virtual machine 190b may typically exit directly to userspace 170 without saving the virtual machine context 140. In such a scenario, the processing deice 110 may check whether the virtual machine context 140 should be saved to the storage 130 or the supervisor context 150 should be loaded to the memory 120 only when the flag is set. Some virtual machine types may typically require exits to the userspace 170 and other virtual machine types may typically require exits to the supervisor 180. This characteristic, and/or a typical configuration for saving the virtual machine context 140, may be identified prior to execution of the second virtual machine 190b and used to determine a default exit status. With the default exit status determined, the processing device 110 may only need to check to see if a flag in an exit request is set before processing an exit request, only determining what action different from the default should be taken when the flag is set.

At block 414, the example processing device determines whether a supervisor context switch is required. For example, upon determining that the flag is not set, the processing device 110 may determine that a supervisor context 150 switch is not required and that the virtual machine context 140 does not need to be saved to the storage 130 without having to check any other flags or registers. This process may be identical to that described in block 404, or may be consistent with the flag system described in block 412.

At block 416, the example processing device loads the supervisor context. For example, the processing device 110 may save the virtual machine context 140 to the storage 130 before loading the supervisor context 150 into the memory 120. As with block 406, the virtual machine context 140 may or may not be saved to the storage 130 prior to the loading of the supervisor context 150.

At block 418, the example processing device loads the userspace context without loading the supervisor context. For example, the processing device 110 may save the virtual machine context 140 to the storage 130 before retrieving the userspace context 160 along with the address of the next instruction from the storage 130. The processing device 110 then loads the userspace context 160 into the memory 120 and begins execution from the address of the next instruction retrieved from the storage 130. This may involve retrieving an address of a next instruction in a userspace 170 instruction set from the storage 130 along with the userspace context 160. The processing device 110 may then load the userspace context 160 into the memory 120 and begin execution of the userspace 170 starting at the address retrieved from the storage 130.

FIG. 5 illustrates a flowchart of an example method 500 for determining what context to load, according to example embodiments of the present disclosure. It will be appreciated that the method 500 is presented with a high degree of abstraction, and that additional steps not mentioned herein or substeps of steps included herein may be included.

At block 502, an example processing device executes a supervisor. For example, the supervisor 180 may begin execution responsive to user input requesting execution of the first virtual machine 190a and after the userspace context 160 has been saved to the storage 130. A userspace context 160 along with an address of a next command in a userspace 170 instruction set may be saved to a storage 130 prior to executing the supervisor 180. The supervisor 180 may be executed in preparation for execution of a first virtual machine 190a.

At block 504 the example processing device 110 executes a first virtual machine on the supervisor 180. For example, the first virtual machine 190a may begin execution after the processing device 110 saves the supervisor context 150 to the storage 130. The first virtual machine 190a may, for example, execute three applications while accepting user input to interact with the three applications. The processing device 110 may execute a plurality of applications within the first virtual machine 190a, and the first virtual machine 190a may accept user input during execution. The supervisor context 150 may be saved to the storage 130 prior to execution of the first virtual machine 190a.

At block 506, the example processing device detects an exit from the first virtual machine with an exit status of a first type or a second type. For example, the processing device 110 may receive an exit request of the first type triggered by a crash of the first virtual machine 190a. The exit may be triggered by any of a number of events, including but not limited to a failure of an application running in the first virtual machine 190a, user input, a page fault, a supervisor error, a userspace error, or any other event which requires execution of the supervisor 180 or the userspace 170. The first type may be indicative of a switch to the supervisor 180, while the second type may be indicative of a switch to the userspace 170.

At block 508, the example processing device determines whether the exit is of the first type. For example, the processing device 110 may inspect a log file associated with the exit and determine that the exit was caused by a crash of the first virtual machine 190a. The processing device 110 may then consult a ruleset that states that a crash of the first virtual machine 190a results in an exit of the first type, therefore determining that the exit is of the first type. A determination that an exit is of the first type may involve one or more of checking a flag, inspecting a reason for the exit, receiving a separate message indicative of the exit type, other indicators of exit type, or combinations thereof.

At block 510, the example processing device loads the supervisor context from the storage to the memory. For example, the processing device 110, having determined that the exit was caused by a crash of the first virtual machine 190a, may load the supervisor context 150 to the memory 120 from the storage 130 without first saving the virtual machine context 140. This may be preceded by the processing device 110 saving the virtual machine context 140 to the storage 130.

At block 512, the example processing device loads the userspace context from the storage to the memory. For example, the processing device 110, having determined that the exit was caused by user input, may first save the virtual machine context 140 to the memory 120 before loading the userspace context 160 from the storage 130. This may be preceded by the processing device 110 saving the virtual machine context 140 to the storage 130.

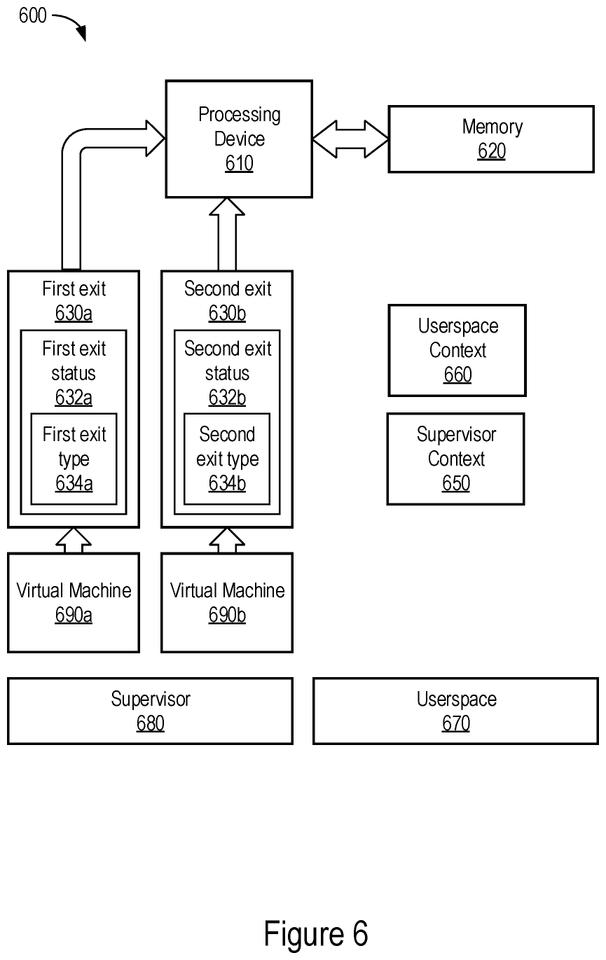

FIG. 6 illustrates a block diagram of an example system 600 with data flows, according to example embodiments of the present disclosure. A userspace 670 executes on the system 600 that includes a processing device 610 and a memory 620. The userspace 670 is associated with a userspace context 660 which is held in the memory 620 while the userspace 670 executes. Responsive to a request to execute a first virtual machine 690a, a supervisor may begin execution, causing the processing device 610 to save the userspace context 660 and to overwrite the memory 620 with a supervisor context 650. The supervisor context 650 may be created upon an initial execution of the supervisor 680.

When the supervisor 680 is ready, the processing device 610 may begin execution of the first virtual machine 690a. After some time passes, the virtual machine 690a may send a request for a first exit 630a to the processing device 610. The first exit 630a may include a first exit status 632a, which may include information about the first exit 630a, including but not limited to a reason for the first exit 630a, a time of the first exit 630a, and/or a type of the first exit as being of a first type 634a or a second type 634b. The first type 634a may be indicative of a need to switch to the supervisor 680 while the second type 634b may be indicative of a need to switch to the userspace 670. The processing device 610 may inspect the first exit status 632a to determine that the first exit 630a is of the first type 634a, causing the processing device 610 to load the supervisor context 650 into the memory 620.

The processing device 610 may subsequently execute a second virtual machine 690b. The second virtual machine 690b may similarly send a request for request a second exit 630b to the processing device 610. The processing device may inspect a second exit status 632b included in the request for the second exit 630b and determine that the second exit 630b is of the second type 634b. The processing device may then load the userspace context 660 into the memory 620. The processing device 610 may first save contents of the memory 620 before overwriting the memory 620 with the userspace context 660.

It will be appreciated that all of the disclosed methods and procedures described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as infrastructure processing units (IPUs), graphical processing units (GPUs), data processing units (DPUs), ASICs, FPGAs, DSPs or any other similar devices. The instructions may be configured to be executed by one or more processors, which when executing the series of computer instructions, performs or facilitates the performance of all or part of the disclosed methods and procedures. As will be appreciated by one of skill in the art, the functionality of the program modules may be combined or distributed as desired in various aspects of the disclosure.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Accordingly, the scope of the invention should be determined not by the embodiments illustrated, but by the appended claims and their equivalents.

What is claimed:

1. A method, comprising:
executing a supervisor;
executing a first virtual machine on the supervisor;
detecting a first exit from the first virtual machine;
responsive to detecting the first exit, loading a userspace context without loading a supervisor context;
executing a second virtual machine on the supervisor;
detecting a second exit from the second virtual machine; and
responsive to detecting the second exit, loading the supervisor context.

2. The method of claim 1, wherein the first virtual machine and the second virtual machine are a same virtual machine.

3. The method of claim 1, further comprising:
inspecting a first exit status to determine whether a supervisor context switch is required for the first exit; and
responsive to the first exit not requiring the supervisor context switch, loading the userspace context without loading the supervisor context.

4. The method of claim 1, further comprising:
inspecting a second exit status to determine whether a supervisor context switch is required for the second exit; and
responsive to the second exit requiring the supervisor context switch, loading the supervisor context.

5. The method of claim 4, wherein the second exit status is a page fault or timer interrupt.

6. The method of claim 1, further comprising:
saving a first guest context of the first virtual machine to storage; and
saving a second guest context of the second virtual machine to storage.

7. The method of claim 6, further comprising:
loading the first guest context or the second guest context into memory.

8. The method of claim 1, further comprising:
saving the userspace context to storage.

9. The method of claim 8, wherein the userspace context is stored on a userspace stack.

10. A system, comprising:
a memory; and
a processing device, configured to
execute a supervisor,
execute a first virtual machine on the supervisor,
detect a first exit from the first virtual machine, wherein the first exit has a first exit status that is one of a first type or a second type,
determine the first exit status as being of the first type,
responsive to determining the first exit status is of the first type, load a supervisor context,
execute a second virtual machine on the supervisor,
detect a second exit from a second virtual machine, wherein the second exit has a second exit status that is one of the first type or the second type,
determine the second exit status as being of the second type,
responsive to determining the second exit status is of the second type, load a userspace context.

11. The system of claim 10, wherein the second type is indicative of a page fault or a timer interrupt.

12. The system of claim 10, wherein the processing device is further configured to:
save a context of at least one of the first virtual machine and the second virtual machine to storage responsive to detecting an exit from the virtual machine and before loading a new context.

13. The system of claim 12, wherein the processing device is further configured to:
load the context of at least one of the first virtual machine and the second virtual machine into memory.

14. The system of claim 10, wherein the processing device is further configured to:
save the userspace context to storage responsive to a request to execute the supervisor.

15. The system of claim 10, wherein the system is further configured to:
store the userspace context on a userspace stack.

16. The system of claim 10, wherein the determining the first exit status and the determining the second exit status includes:
checking whether an exit status is of the first type; and
responsive to determining that the exit status is not of the first type, determining that the exit status is of the second type.

17. The system of claim 10, wherein the determining the first exit status and the determining the second exit status includes:
checking whether an exit status is of the second type; and
responsive to determining that the exit status is not of the second type, determining that the exit status is of the first type.

18. A non-volatile computer-readable memory storing instructions which, when executed by a processing device, cause the processing device to:
execute a supervisor,
execute a first virtual machine on the supervisor,
detect a first exit from the first virtual machine, wherein the first exit has a first exit status that is one of a first type or a second type,
determine the first exit status as being of the first type,
responsive to determining the first exit status is of the first type, load a supervisor context,
execute a second virtual machine on the supervisor,
detect a second exit from a second virtual machine, wherein the second exit has a second exit status that is one of the first type or the second type,
determine the second exit status as being of the second type,
responsive to determining the second exit status is of the second type, load a userspace context.

19. The non-volatile computer-readable memory of claim 18, wherein the determining the first exit status and the determining the second exit status include:
checking whether an exit status is of the first type; and
responsive to determining that the exit status is not of the first type, determining that the exit status is of the second type.

20. The non-volatile computer-readable memory of claim 18, wherein the determining the first exit status and the determining the second exit status include:
checking whether an exit status is of the second type; and
responsive to determining that the exit status is not of the second type, determining that the exit status is of the first type.
